(19) United States
(12) Patent Application Publication
(10) Pub. No.: US 2016/0098118 A1
(43) Pub. Date: Apr. 7, 2016

(54) CAPACITIVE TOUCH DEVICE AND EXCITATION SIGNAL GENERATING CIRCUIT AND METHOD THEREOF

(71) Applicant: ELAN Microelectronics Corporation, Hsinchu (TW)

(72) Inventors: Chia-Hsing Lin, Hsinchu City (TW); Han-Wei Chen, Taipei City (TW); Jyun-Yu Chen, New Taipei City (TW)

(73) Assignee: ELAN MICROELECTRONICS CORPORATION, Hsinchu (TW)

(21) Appl. No.: 14/826,002

(22) Filed: Aug. 13, 2015

(30) Foreign Application Priority Data
Oct. 1, 2014 (TW) 103134173

(51) Int. Cl. G06F 3/044

(52) U.S. Cl. CPC G06F 3/044

(57) ABSTRACT

The present invention is related to a capacitive touch device and excitation signal generating circuit and method thereof. The excitation signal generating circuit is connected to multiple sensing traces of the capacitive touch device, and has a storage unit storing at least one set of digital data. Each set of digital data is corresponding to a frequency. The PDM signal generator reads the set of digital data and converts the read set of digital data to a PDM signal according to the frequency of the read set of digital data. The PDM signal is recovered to an analog excitation signal since the PDM signal passes through a current transmission path, which is equivalent to a low pass filter. Therefore, the present invention can decrease a distortion of the sensing signal to increase accuracy of the sensing signal and to save power.

### CROSS-REFERENCE TO RELATED APPLICATIONS

This application is based upon and claims priority under 35 U.S.C. 119 from Taiwan Patent Application No. 103134173 filed on Oct. 1, 2014, which is hereby specifically incorporated herein by this reference thereto.

### BACKGROUND OF THE INVENTION

1. Field of the Invention

The present invention is related to a capacitive touch device, and more particularly to an excitation signal generating circuit and method of the capacitive touch device.

2. Description of the Prior Arts

A conventional capacitive touch device has a touch panel and a scanning circuit. The touch panel has multiple sensing traces, and the scanning circuit provides an excitation signal to parts or all of the sensing traces in sequence. A charging current is generated on the sensing trace to which the excitation signal is supplied based on the influence of capacitance effect. After a period of charging time, the charging current on the sensing trace is stable. At the time, a discharging current on the same sensing trace can be read, or a induced current on another sensing trace crossing to the sensing trace to which the excitation signal is supplied can be read. Then the read discharging current or the read induced current is further converted to a valid capacitance sensing value. A position of a touch on the touch panel can be identified by determining a variation of the capacitance sensing value.

A distance between one end of each sensing trace and the excitation circuit is different since the sensing traces are formed on different positions on the touch panel. Therefore, the charging times of the sensing traces are not the same. For example, with reference to FIG. 10, when the excitation signal is supplied to the two ends of the sensing trace TX1˜TX40 along a first axis at the same time, a current transmission path ph1 from the first sensing trace TX1 along the first axis to the middle sensing trace RX35 along a second axis is the longest. That is, transmitting the charging current on the longest current transmission path ph1 requires the most charging time, too. On the contrary, a current transmission path ph2 from the last sensing trace TX40 along the first axis to the second sensing trace RX1 along the second axis is the shortest, so transmitting the charging current on the shortest current transmission path ph2 requires the least charging time, too. In general, the capacitive touch device uses square wave signal or sine wave signal as the excitation signal. With reference to FIGS. 11A-1 and 11A-2, two frequency spectrum diagrams of the two current sensing signals from the middle sensing trace RX35 and the first sensing trace RX1, after the square wave signals are separately supplied to the first sensing trace TX1 of the longest current transmission path ph1 and the last sensing trace TX40 of the shortest current transmission path ph2. With further reference to FIGS. 11B-1 and 11B-2, two frequency spectrum diagrams of the two current sensing signals from the middle sensing trace RX35 and the first sensing trace RX1, after the sine wave signals are separately supplied to the first sensing trace TX1 of the longest current transmission path ph1 and the last sensing trace TX40 of the shortest current transmission path ph2. Using the sine wave signal as the excitation signal makes a low distortion of the current sensing signal from the longest or shortest transmission paths ph1, ph2 in comparison with using square wave signal as the excitation signal. With reference to FIG. 12A, four capacitance sensing value curves corresponding to four different square wave signals supplied to four sensing traces TX1, TX5, TX10 and TX20 along the first axis are shown. Each curve is consisted of multiple capacitance sensing values converted by an analog to digital conversion from the current sensing signals of 12 sensing traces along the second axis. The capacitance sensing values corresponding to longer current transmission paths are higher than those corresponding to shorter current transmission paths. With further reference to FIG. 12B, four since wave signals replaced the square wave signals are supplied to the four sensing traces TX1, TX5, TX10 and TX20 along the first axis are shown, and four curves of FIG. 12B are more even than those of FIG. 12A. Therefore, the variations of the current sensing signals are slightly effected by the distances of the current transmission paths.

With reference to FIG. 13, the scanning circuit of the capacitive touch device has an excitation signal generator 60 and a receiving circuit 70 separately connected to the sensing traces 51 on the touch panel 50. The excitation signal generator 60 has an analog signal generating unit 61 and multiple amplifiers 62. The analog signal generating unit 61 generates an analog sine wave signal Sa, and the corresponding amplifier 62 amplifies the analog sine wave signal Sa. The amplified analog sine wave signal Sa is further output to the sensing trace 51 connected to the amplifier 62. Therefore, the excitation signal generator 60 outputs the analog sine wave signal Sa as the excitation signal. The receiving circuit 70 converts the analog sensing signal to digital capacitance sensing value to calculate a correct position of the touch.

Based on foregoing description, the excitation signal generator can output since wave signal as the excitation signal, but the excitation signal generator requires the amplifiers to amplify the analog sine wave signal. Therefore, the excitation signal generator has higher power consumption and also increases manufacturing cost for a larger size touch panel with more sensing traces. In addition, the analog signal generating unit has an analog circuit, which requires a larger layout area of chip if the analog generating unit is in the form of the integrated circuit.

To overcome the shortcomings, the present invention provides an n excitation signal generating circuit to mitigate or obviate the aforementioned problems.

### SUMMARY OF THE INVENTION

The objective of the present invention provides an excitation signal generating circuit with a simple circuit structure, a method of generating the excitation signal and a capacitive touch device using the excitation signal generating circuit to solve the signal distortion, high power consumption, and high manufacturing cost etc. drawbacks.

To achieve the objective, the excitation signal generating circuit is electronically connected to multiple sensing traces of the capacitive touch device and has a storage unit and a pulse density modulation (hereinafter PDM) signal generating circuit.

The storage unit stores at least one set of digital data and each set of digital data corresponds to a frequency.

The PDM signal generating circuit is connected to the storage unit and the sensing traces to read the at least one set of digital data. The PDM signal generating circuit converts the set of digital data to a PDM signal according to the frequency of the read set of digital data, and then outputs the PDM signal to the sensing traces.

The excitation signal generating circuit of the present invention directly generates the PDM signal as an excitation signal output to the sensing traces. The PDM signal is recovered to an analog excitation signal since the PDM signal passes through a current transmission path, which is equivalent to a low pass filter. Therefore, a receiving circuit receives an available analog sensing signal with low signal distortion to increase accuracy of the current sensing signal. Further, the excitation signal generating circuit does not require amplifiers to amplify the PDM signal, so a circuit structure of the excitation signal generating circuit is simplified, a manufacturing cost can be reduced, and the power consumption is low.

To achieve the objective, the capacitive touch device has a touch panel, an excitation signal generating circuit having a storage unit, a PDM signal generating circuit and a receiving circuit.

The touch panel has multiple sensing traces.

The storage unit stores at least one set of digital data and each set of digital data corresponds to a frequency. The PDM signal generating circuit is connected to the storage unit and the sensing traces to read the at least one set of digital data. The PDM signal generating circuit converts the set of digital data to a PDM signal according to the frequency of the read set of digital data, and then outputs the PDM signal to the sensing traces.

The receiving circuit is connected to the sensing traces of the touch panel to receive an analog signal of each sensing trace corresponding to the sensing trace to which the PDM signal is supplied.

The capacitive touch device of the present invention directly generates the PDM signal as an excitation signal output to the sensing traces. The PDM signal is recovered to an analog excitation signal since the PDM signal passes through a current transmission path, which is equivalent to a low pass filter. Therefore, a receiving circuit receives an available analog sensing signal with low signal distortion to increase accuracy of the current sensing signal. Further, the capacitive touch device does not require amplifiers to amplify the PDM signal, so a circuit structure of the excitation signal generating circuit is simplified, a manufacturing cost can be reduced, and the power consumption is low.

To achieve the objective, the method of generating excitation signal has steps of: storing at least one set of digital data, wherein each set of digital data corresponds to a frequency; converting the set of digital data to a PDM signal according to the frequency of the set of digital data; and using the PDM signal as an excitation signal and outputting the PDM signal to the sensing traces.

The generating method generates the PDM signal having a frequency which is the same as a frequency of as an excitation signal, so that the PDM signal is directly output to the sensing traces. The PDM signal is recovered to an analog excitation signal since the PDM signal passes through a current transmission path, which is equivalent to a low pass filter. Therefore, an available analog sensing signal with low signal distortion is received to increase accuracy of the current sensing signal and to save power.

Other objectives, advantages and novel features of the invention will become more apparent from the following detailed description when taken in conjunction with the accompanying drawings.

### BRIEF DESCRIPTION OF THE DRAWINGS

FIG. 1A is a functional block diagram of a first preferred embodiment of a capacitive touch device in accordance with the present invention;

FIG. 1B is another functional block diagram of a first preferred embodiment of a capacitive touch device in accordance with the present invention;

FIGS. 2A and 2B are waveform diagrams respectively showing two PDM signals and two since wave signals with different frequencies;

FIG. 3 is a functional diagram of an analog to digital converter of a receiving circuit;

FIGS. 4A and 4B are two capacitance sensing value curve diagrams respectively generated by FIG. 1A and FIG. 1B;

FIG. 5A is a functional block diagram of a second preferred embodiment of a capacitive touch device in accordance with the present invention;

FIG. 5B is another functional block diagram of the second preferred embodiment of a capacitive touch device in accordance with the present invention;

FIG. 6 is a functional block diagram of a third preferred embodiment of a capacitive touch device in accordance with the present invention;

FIG. 7 is a functional block diagram of a fourth preferred embodiment of a capacitive touch device in accordance with the present invention;

FIG. 8 is a functional block diagram of a fifth preferred embodiment of a capacitive touch device in accordance with the present invention;

FIG. 9 is a functional block diagram of a signal converting unit in accordance with the present invention;

FIG. 10 is a schematic diagram of a conventional capacitive touch device in accordance with the prior art;

FIGS. 11A-1 and 11A-2 are two frequency spectrum diagrams of the two sensing signals received from a shortest and longest current transmission paths to which a square wave signal is supplied;

FIGS. 11B-1 and 11B-2 are two frequency spectrum diagrams of the two sensing signals received from a shortest and longest current transmission paths to which a sine wave signal is supplied;

FIG. 12A is a capacitance sensing value curve diagram showing four capacitance sensing value curves corresponding to four different square wave signals to four sensing traces taken along the first axis are shown;

FIG. 12B is a capacitance sensing value curve diagram showing four capacitance sensing value curves corresponding to four different sine wave signals to four sensing traces taken along the first axis are shown; and

FIG. 13 is a functional block diagram of a scanning circuit of a conventional touch device in accordance with the prior art.

### DETAILED DESCRIPTION OF THE PREFERRED EMBODIMENTS

The present invention provides an improved excitation signal generating circuit of a capacitive touch device to simplify the circuit structure thereof.

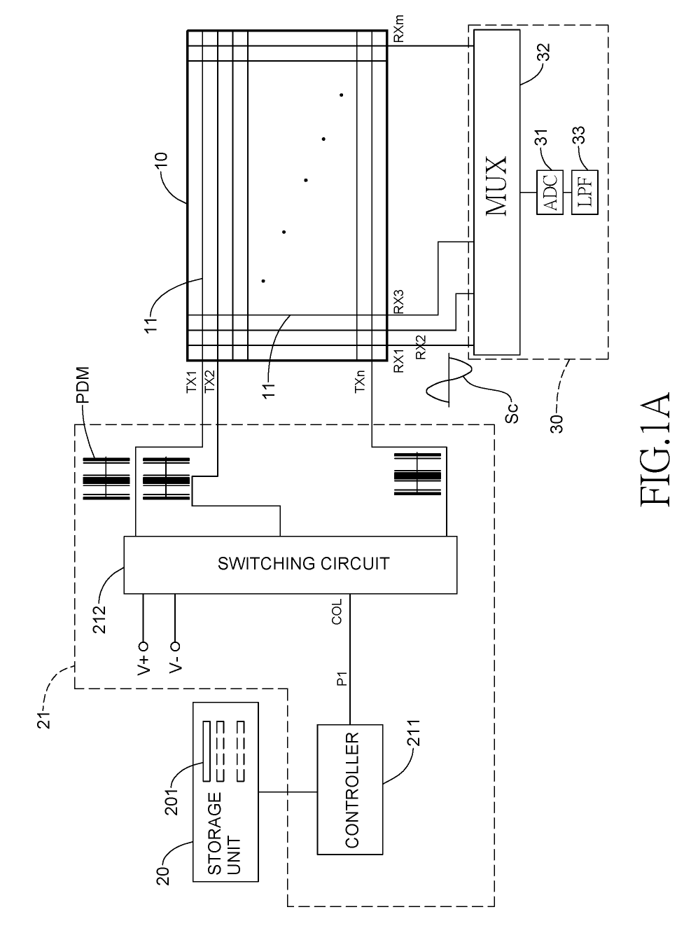

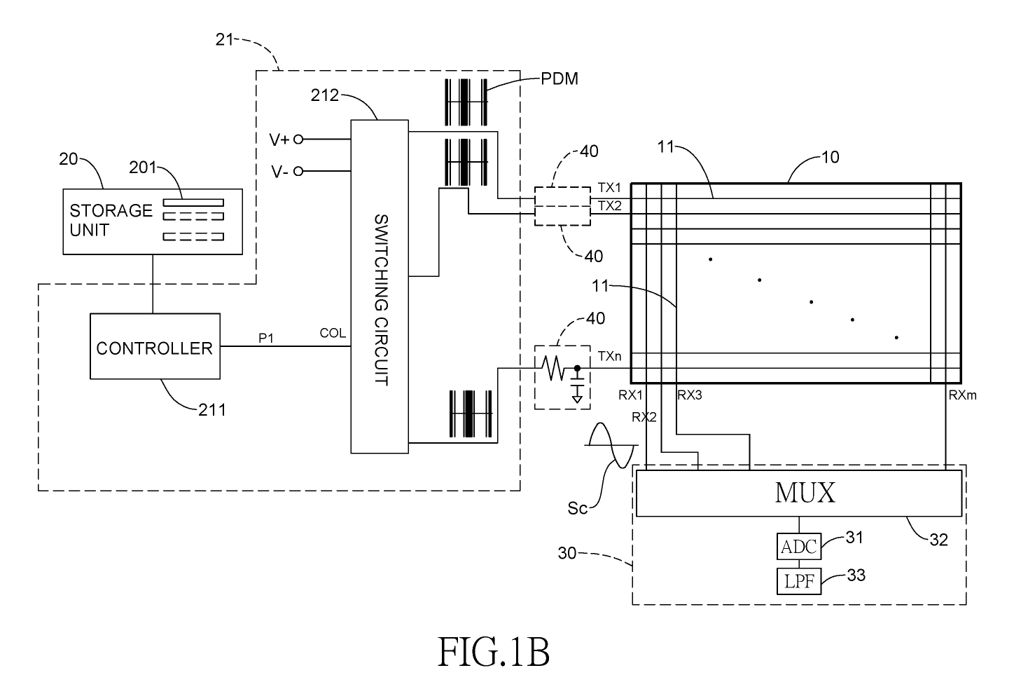

With reference to FIG. 1A, a capacitive touch device of a first preferred embodiment of the present invention has a touch panel 10, an excitation signal generating circuit (not numbered) and a receiving circuit 30.

The touch panel 10 has multiple sensing traces 11 including multiple first axis sensing traces and a second axis sensing traces crossing the first axis sensing traces. In the first preferred embodiment, a mutual-capacitive scanning method is used as an example so the first axis sensing traces are used as driving traces TX1˜TXn and the second axis sensing traces are used as sensing traces RX1˜RXm. If a self-capacitive scanning method is used, each sensing trace is used as the driving and receiving trace.

The excitation signal generating circuit has a storage unit 20 and a pulse density modulation (hereinafter PDM) signal generating circuit 21. The storage 20 stores at least one set of digital data. Each set of digital data corresponds to a frequency. The PDM signal generating circuit 21 is connected to the storage unit 20 and multiple sensing traces 11 to read the at least one set of digital data. The PDM signal generating circuit 21 also converts the read set of digital data to a PDM signal according to the frequency of the read set of digital data. The PDM signal is further supplied to the sensing traces as an excitation signal. When the mutual-capacitive scanning is employed, the PDM signal is supplied to the first axis sensing traces TX1˜TXn used as the driving traces. In the first preferred embodiment, the set of digital data stored in storage unit 20 is a set of PDM digital data and each set of PDM digital data is consisted of digital values +1 and −1, so the storage unit 20 can store one or more sets of PDM digital data in one or more look-up tables 201 in the storage unit 20. In the first preferred embodiment, the PDM signal generating circuit 21 has as controller 211 and a switching circuit 212. The switching circuit 212 has a control terminal COL, two switching terminals and multiple output terminals. The controller 211 is connected to the storage unit 20 and the control terminal COL of the switching circuit 212. The multiple output terminals of the switching circuit 212 are respectively connected to the corresponding first axis sensing traces TX1˜TXn. The two switching terminals of the switching circuit 212 are respectively connected to two voltage terminals V+ and V−. Therefore, the controller 211 outputs a control signal to the control terminal COL of the switching circuit 212 and the switch circuit 212 switches each output terminal to one of the two switching terminals according to the control signal.

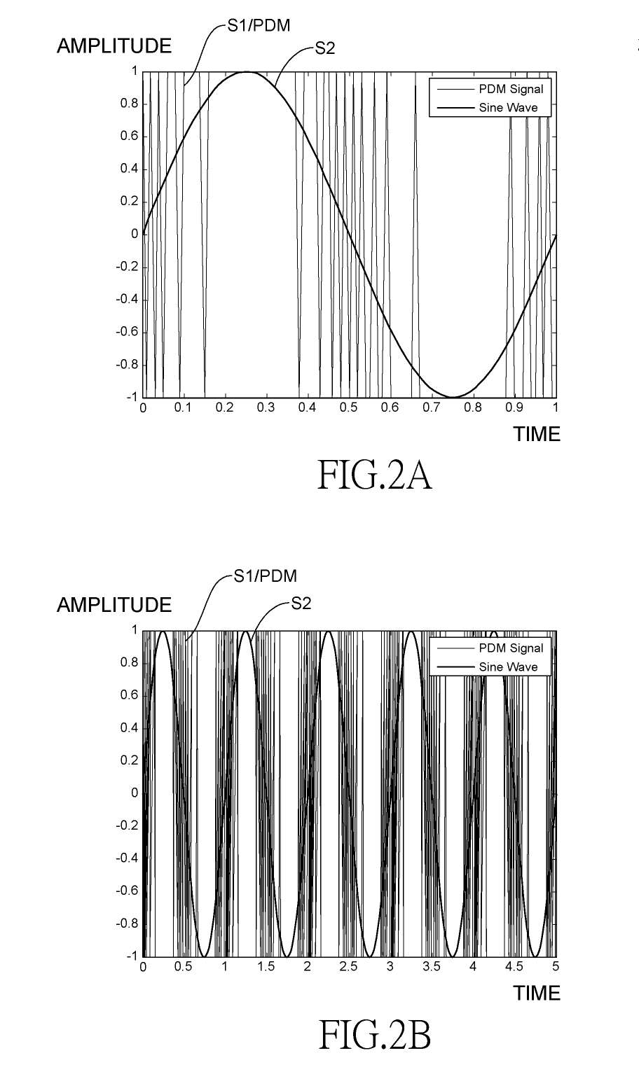

When the controller 211 reads one set of the PDM digital data from the storage unit 20. The controller 211 outputs the control signal to the control terminal COL of the switching circuit 212 according to the read set of PDM digital data and the frequency thereof. Each output terminal of the switching circuit 212 outputs a PDM signal according to the read set of the PDM digital data, since each output terminal is switched to the voltage terminal V+ if the present read PDM data is +1 or switched to another voltage terminal V− if the present read PDM data is −1. The PDM single is outputted to the corresponding first axis sensing trace TX1, TX2 . . . or TXn. In a preferred embodiment, the set of PDM digital data is stored in 1-bit look-up tale 201 of the storage unit 20. With further reference to FIG. 2A, if the frequency of the read set of PDM digital data is 100 kHz, the switching circuit outputs a PDM signal S1 with 100 kHz frequency and the PDM signal S1 corresponds to a sine wave signal S2 with 100 kHz frequency. With reference to FIG. 2B, if the frequency of the read set of PDM digital data is 500 kHz higher than 100 kHz, the switching circuit 212 outputs a PDM signal S1 with 500 kHz and the PDM signal S1 corresponds to a sine wave signal S2 with the 500 kHz frequency.

Based on foregoing description, a switching frequency of the switching circuit 212 has to be higher than that of the set of PDM digital data to successfully output a correct PDM signal. Therefore, a switching frequency of the switching circuit 212 and the frequency of the set of PDM digital data has to be complied with an equation: fsw/fs>n, wherein n is an integer and greater than 4 or equal to 4.

The receiving circuit 30 is connected to the sensing traces 11 of the touch panel 10 to receive an analog sensing signal Sc from each sensing trace crossing to the driven sensing trace to which the PDM signal is supplied, and then converts the analog sensing signal Sc to a digital capacitance sensing value. Since the first embodiment employs the mutual-capacitive scanning, the receiving circuit 30 is connected to the second axis sensing traces RX1˜RXm. In the first preferred embodiment, the receiving circuit 30 has a one to many multiplexer 32, an analog to digital converter (hereinafter ADC) 31 and a low pass filter (LPF hereinafter) 33. The one to many multiplexer 32 has multiple output pins and a common pin. The output pins of the one to many multiplexer 32 are respectively connected to the second axis sensing traces RX1˜RXm. The common pin of the one to many multiplexer 32 is connected to the ADC 31 to respectively receive the analog sensing signal Sc from the second axis sensing traces RX1˜RXm. The ADC 31 converts the analog sensing signal Sc to the digital capacitance sensing value. The LPF 33 is connected to the ADC 31.

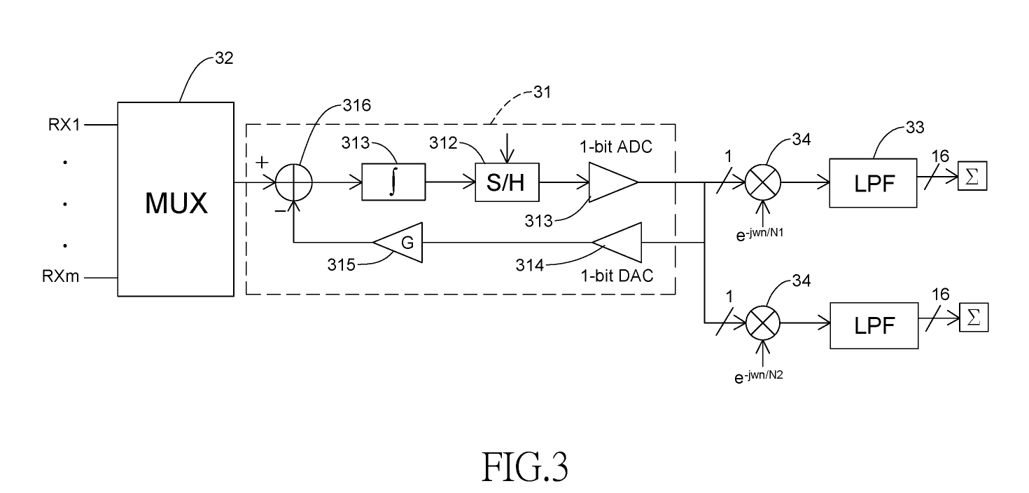

With further reference to FIG. 3, each ADC 31 of the receiving circuit 30 is a 1-bit Sigma-Delta ADC and has a digital integrator 311, a sample and hold circuit 312 and a 1-bit ADC 313 from input to output. An output terminal of the 1-bit ADC 313 is connected to a feedback circuit. The feedback circuit has a 1-bit digital to analog converter (hereinafter DAC) 314 and a gain amplifier 315. An input terminal of the 1-bit DAC 314 is connected to the output terminal of the 1-bit ADC 313, and an output terminal of the 1-bit DAC 314 is connected to the gain amplifier 315 to amplify the signal. The amplified signal is fed back to an input terminal of the digital integrator 311 through an adder 316. In addition, the output terminal of the 1-bit ADC 313 is connected to the LPF 33 through a mixer 34 and an oscillating frequency of the mixer 34 is the same as the frequency of the analog sensing signal Sc so that the valid capacitance sensing value is extracted. The extracted capacitance sensing value is further input to the LPF 33 and the LPF 33 filters a high frequency noise of the extracted capacitance sensing value. Furthermore, the output terminal of 1-bit ADC 313 of the receiving circuit 30 may be further connected to the LPFs 33 through the multiple mixers 34. The oscillating frequencies of the mixers 34 respectively correspond to the frequencies of the different analog sensing signals. The LPFs 33 respectively filter the high frequency noises from the capacitance sensing values and outputs the filtered capacitance sensing values corresponding to the analog sensing signals.

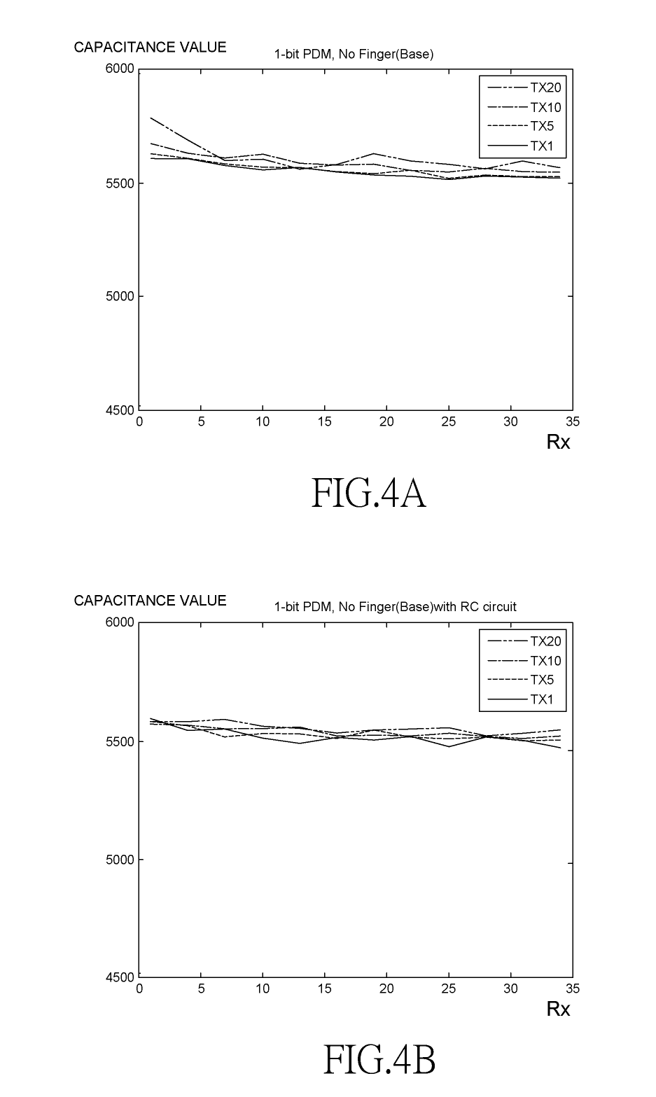

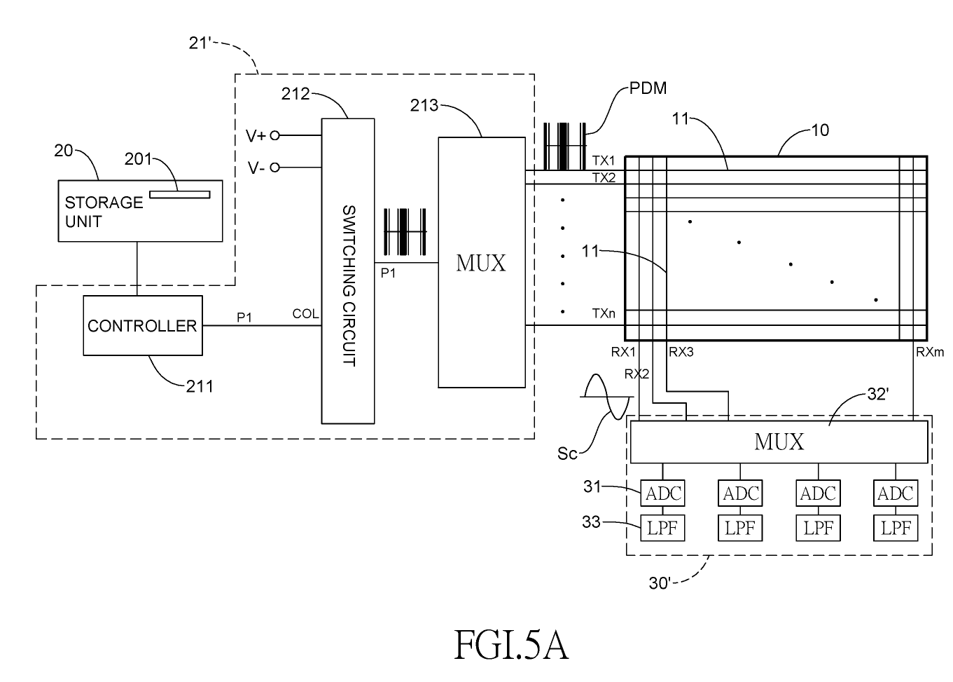

Based on the foregoing description of the first preferred embodiment, the excitation signal generating circuit 20 of the present invention stores the sets of digital data, whose frequencies respectively correspond to frequencies of the excitation signals. The set of digital data is the set of the PDM digital data so that a PDM signal can be generated as the excitation signal and outputted to the sensing traces 11. The PDM signal is recovered to the analog sensing signal Sc, since the PDM signal is transmitted to a current transmission path, which is equivalent to a low pass filter and the current transmission path is from one end of the sensing trance 11, to which the PDM signal is outputted, to one end of the sensing trance 11 connected to the receiving circuit 30. With further reference to FIG. 4A, when touch object, such as finger, does not touch on the touch panel 10, four PDM signals are respectively supplied to the first axis sensing traces TX1, TX5, TX10 and TX20. After the PDM signal is supplied to one of the first axis sensing traces TX1, TX5, TX10 and TX20, the receiving circuit 30 receives the analog sensing signals from twelve second axis sensing traces RX1, RX3, RX7, RX10, RX13, RX16, RX18, RX23, RX25, RX28, RX31 and RX34. Therefore, the four capacitance sensing value curves are shown on FIG. 4A. Since the touch object does not touch on the touch panel, the capacitance sensing values converted from the analog sensing signals are slightly different and the four curves are even and similar to the curves of using the analog since wave signal as the excitation signal. However, the capacitance sensing value of an intersection of the last one TXn (TX20) of the four first axis sensing traces and the first one RX1 of the twelve second axis sensing traces is quite high. This is because the transmission path from the last one TXn (TX20) of the first axis sensing traces to the first one RX1 of the second axis sensing traces is the shortest. Therefore, the effect of low pass filtering is not good enough so that the capacitance sensing value is higher than others. With further reference to FIG. 1B, multiple RC loading circuits 40 with different RC loadings are respectively connected between the first axis sensing traces TX1˜TXn and the output terminals of the switching circuit 212. Further, the RC loading circuits 40 with RC loads from small to large are respectively connected to the first axis sensing traces TX1˜TXn with the current transmission paths from long to short, i.e. the RC loading circuit with smaller RC load connected to the first axis sensing trace with longer current transmission path and the RC loading circuit with larger RC load connected to the first axis sensing trace with shorter current transmission path. With reference to FIG. 4B, the capacitance sensing values converted from the analog sensing signals are closer for each other than those shown on FIG. 4A. Adding the RC loading circuit 40 avoids that the variations of capacitance sensing values are caused by different distances of the current transmission paths. In addition, the excitation signal generating circuit 20 does not require external amplifiers and the circuit structure thereof can be further simplified to reduce power consumption.

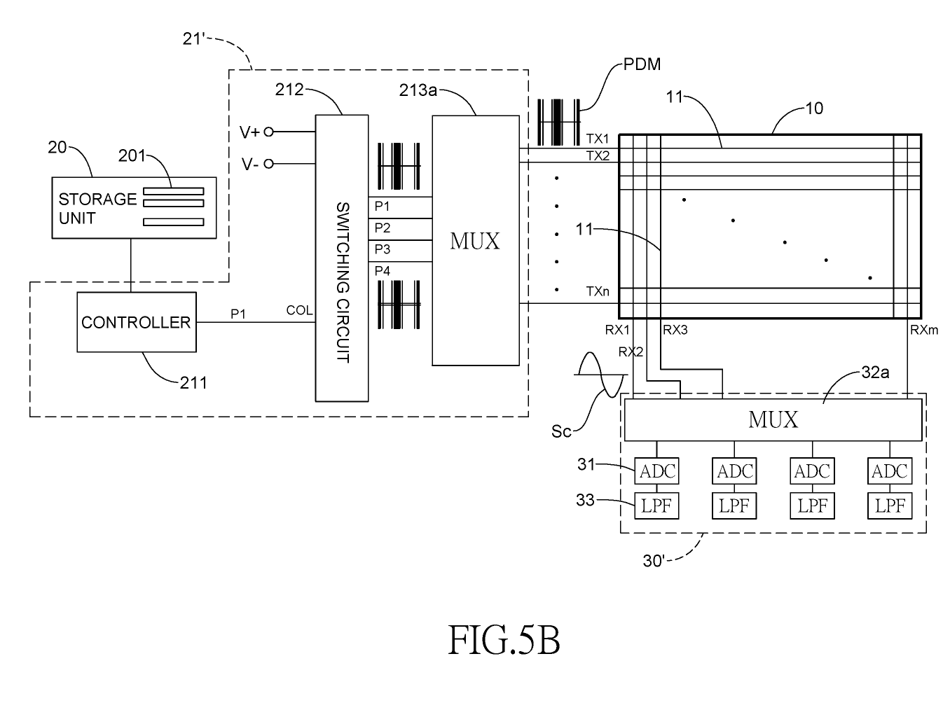

With reference to FIG. 5A, a second preferred embodiment of the present invention is shown and similar to the first preferred embodiment, but a switching circuit 212 of a PDM signal generating circuit 21′ of the second preferred embodiment has only one output terminal P1. In addition, the PDM signal generating circuit 21′ further has an one to many multiplexer 213. The output terminal P1 of the switching circuit 212 is connected to a common pin of the one to many multiplexer 213 and multiple output pins of the one to many multiplexer 213 are respectively connected to the first axis sensing traces TX1˜TXn. Therefore, the PDM signal can be supplied to the first axis sensing traces TX1˜TXn in sequence through the one to many multiplexer 213. With reference to FIG. 5B, another PDM signal generating circuit 21′ is shown and the amount of the output terminals of the switching circuit 212 is more than one but less than the amount of the first axis sensing traces TX1˜TXn (1<x<n), so an many to many multiplexer 213a replaces the one to many multiplexer 213. In this preferred embodiment, x is 4. If the switching circuit 212 has four output terminals P1˜P4, the four common pins of the many to many multiplexer 213a are respectively connected to the output terminals of the switching circuit 212. When the storage unit 20 stores multiple sets of PDM digital data, the controller 211 can read more sets of PDM digital data at the same time. The controller 211 also controls the output terminals of the switching circuit 212 to output multiple different PDM signals at the same time according to the frequency of the set of PDM digital data. The PDM signals may include the sine wave and cosine wave PDM signals having different frequencies and same phases, the sine wave or cosine wave PDM signals having same frequency and different phases. The many to many multiplexer 213a supplies the PDM signals to corresponding to the first axis sensing traces TX1˜TX4, TX5˜TX8, . . . or TXn−3˜TXn at the time. Assuming that the touch panel has 20 first axis sensing traces TX1˜TXn (n=20), the controller 211 controls the switching circuit 212 to generate four PDM signals. The four PDM signals are supplied to four corresponding first axis sensing traces TX1˜TX4 at the same time in a first scanning period. In next scanning period, other four PDM signals are supplied to other four first axis sensing traces TX5 to TX8 at the same time. After five scanning periods, the 20 first axis sensing traces TX1˜TX20 are scanned by the mutual-capacitive scanning method to increase a signal to noise ratio and a frame rate.

In the second preferred embodiment, the receiving circuit 30′ has a many to many multiplexer 32′ and ADCs 31 and y LPFs 33. The many to many multiplexer 32′ has multiple common pins and output pins. The output pins of the many to many multiplexer 32′ are connected to the corresponding ADCs 31 and the output pins of the many to many multiplexer 32′ are connected to the second axis sensing traces RX1˜RXm. With further reference to FIG. 1B, multiple RC loading circuits 40 can be also connected between the output pins of the many to many multiplexer 213a and the first axis sensing traces TX1˜TXn in the second preferred embodiment. The RC loading circuits 40 with RC loads from small to large are respectively connected to the first axis sensing traces with the current transmission paths from long to short, i.e. the RC loading circuit with smaller RC load connected to the first axis sensing trace with longer current transmission path and the RC loading circuit with larger RC load connected to the first axis sensing trace with shorter current transmission path.

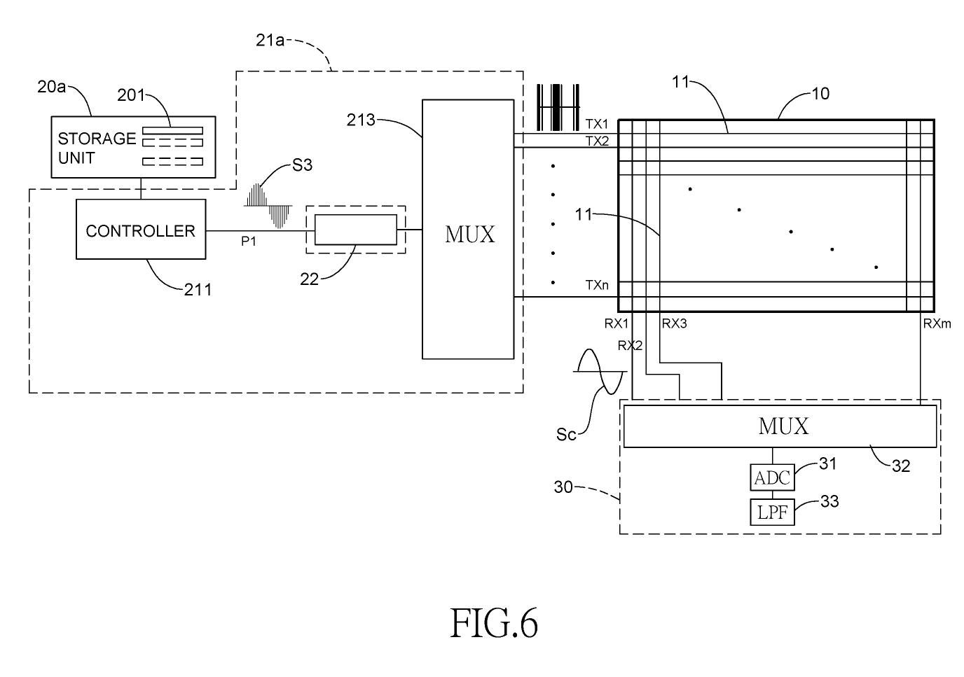

With reference to FIG. 6, a third preferred embodiment of the capacitive touch device of present invention and has a touch panel 10, an excitation signal generating circuit (not numbered) and a receiving circuit 30. The touch panel 10 is the same as that of the first or second preferred embodiment, and the receiving circuit 30 may be the receiving circuit 30 of the first or second preferred embodiment, so the details of the touch panel 10 and receiving circuit 30 are not described here. the excitation signal generating circuit has a storage unit 20a and a PDM signal generating circuit 21a.

In the third preferred embodiment, the set of digital data stored in the storage unit 20a is a set of digital wave data. The set of digital wave data corresponds to a frequency. The PDM signal generating circuit 21a has a controller 211, a single signal converting unit 22 and a one to many multiplexer 213. The controller is connected between the storage 20a and the signal converting unit 22 to read the set of digital wave data, and generates an output signal S3 according to the set of digital wave data and the frequency thereof.

An input terminal of the signal converting unit 22 is connected to the controller 211 to receive the output signal S3 and then converts the output signal S3 to a PDM signal. Preferably, the set of digital wave data is a digital sine wave data by sampling an analog sine wave signal. An amplitude and frequency of the sampled analog sine wave signal are the same as the amplitude and frequency of the set of digital sine wave data. An output terminal of signal converting unit 22 is connected to a common pin of the one to many multiplexer 213, so the PDM signal is supplied to the first axis sensing trace TX1˜TXn in sequence through the one to many multiplexer 213.

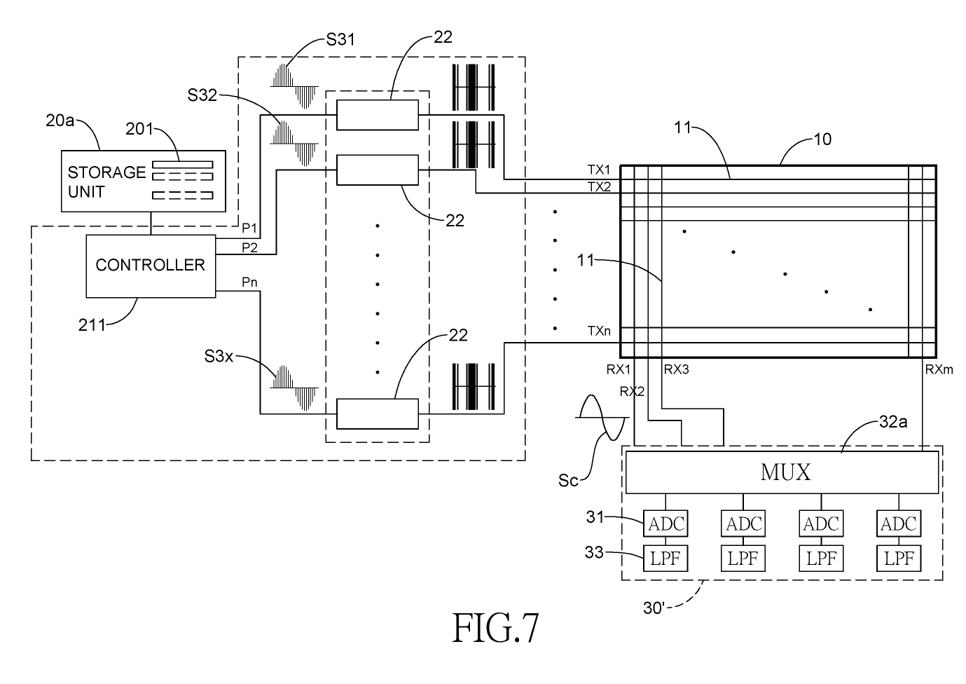

In addition, FIG. 7 shows an fourth preferred embodiment of the capacitive sensing device of the present invention. The storage unit 20a has one or more look-up tables 201 to store one or more sets of digital sine wave data therein. The amount of the signal converting units 22 matches the amount of the first axis sensing trace TX1˜TXn. The output terminal of each signal converting unit 22 is directly connected to the corresponding first axis sensing trace TX1, TX2 . . . or TXn without the one to many multiplexer 213. The controllers 211 decides to output one or more sets of output signals S31˜S3x in one scanning period. The signal converting unit 22 coverts the PDM signal to to the corresponding first axis sensing trace TX1˜TXn. To ensure that the valid analog sensing signals are received from the second axis sensing trace RX1˜RXm after outputting multiple sets of PDM signals, the frequencies of the sets (j) of digital sine wave data meet 2̂(j−1)fs, wherein the fs is the lowest frequency thereof and j is one of the positive integers from 1 to the amount of the sets of digital sine wave data. Therefore, the output signals S31˜S3x generated by the sets of digital sine wave data are orthogonal to each other. In addition, the sets of digital sine wave data stored in the storage unit 20a may include k sets of digital sine and cosine) wave data with the same frequency and phase, or k sets of digital sine wave data with the same frequency but different phases, wherein k>1, or k sets of digital cosine wave data with the same frequency but different phases, wherein k>1.

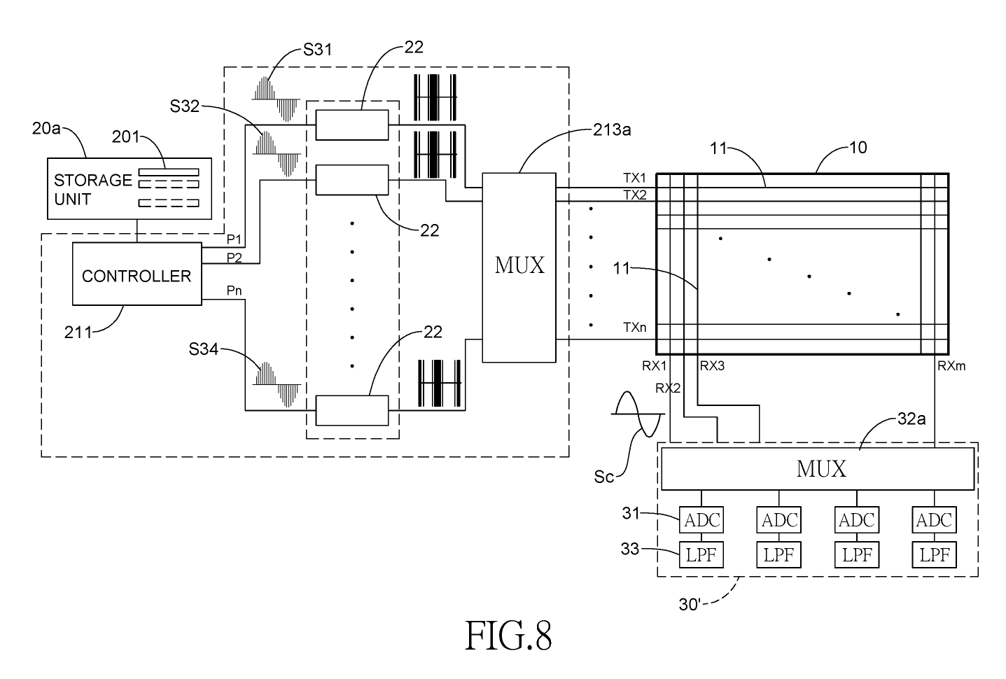

With reference to FIG. 8, a fifth preferred embodiment of the present invention implements a structure of executing a multi-scanning method. During a signal scanning period, multiple PDM signals are supplied to the corresponding first axis sensing traces. Assuming that four PDM signals are respectively supplied to the four first axis sensing traces TX1˜TX4, TX5˜TX8, . . . TXn−3˜TXn in sequence, the fifth preferred embodiment has four signal converting units 22 and a many to many multiplexer 213a. When the controller 211 generates the four output signals S31˜S34 at the time, the four signal converting units 22 convert the four output signals S31˜S34 to four PDM signals. The four PDM signals outputs to four first axis sensing traces TX1˜TX4 in the scanning period. If the amount of the first axis sensing traces are 20, all of the first axis sensing traces TX1˜TX20 are scanned to generate a sensing frame in 5 scanning periods.

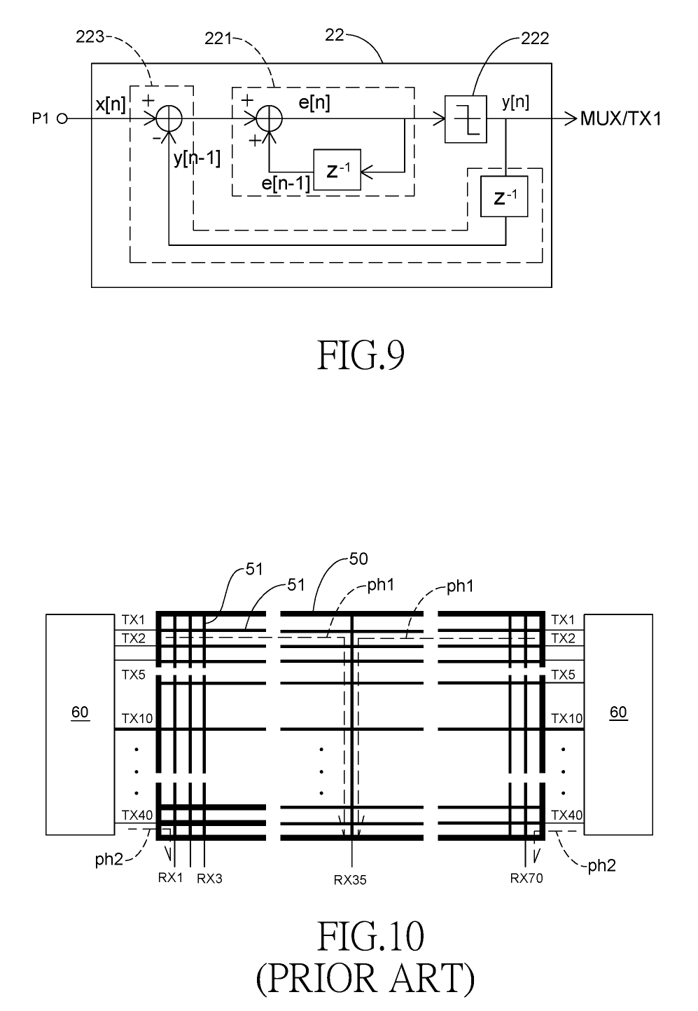

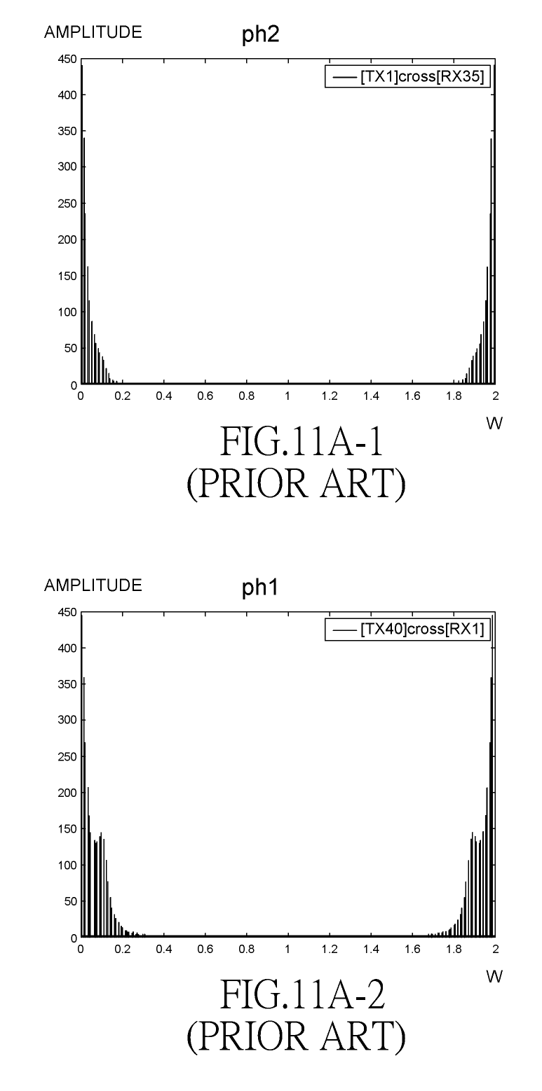

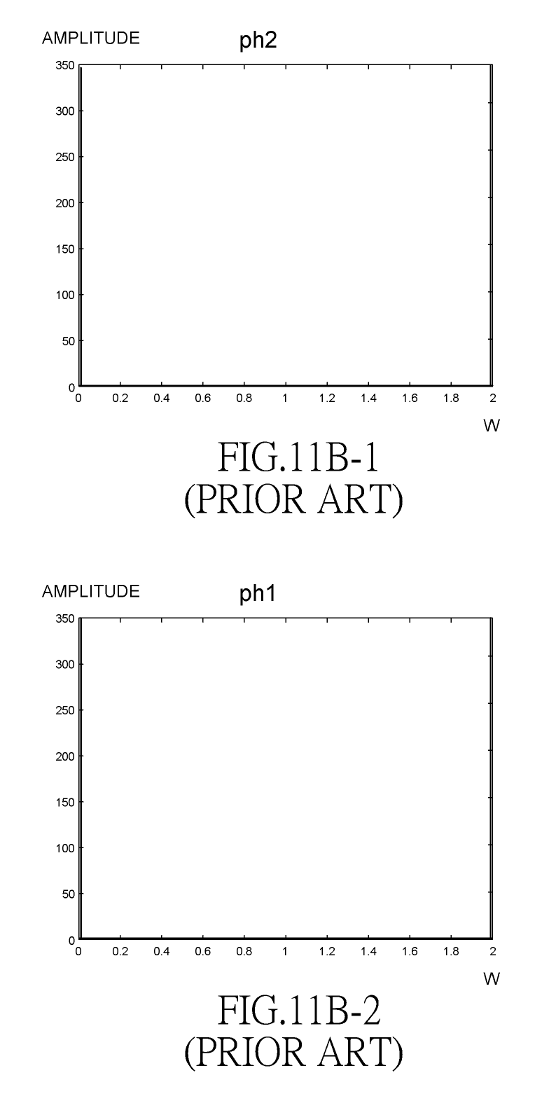

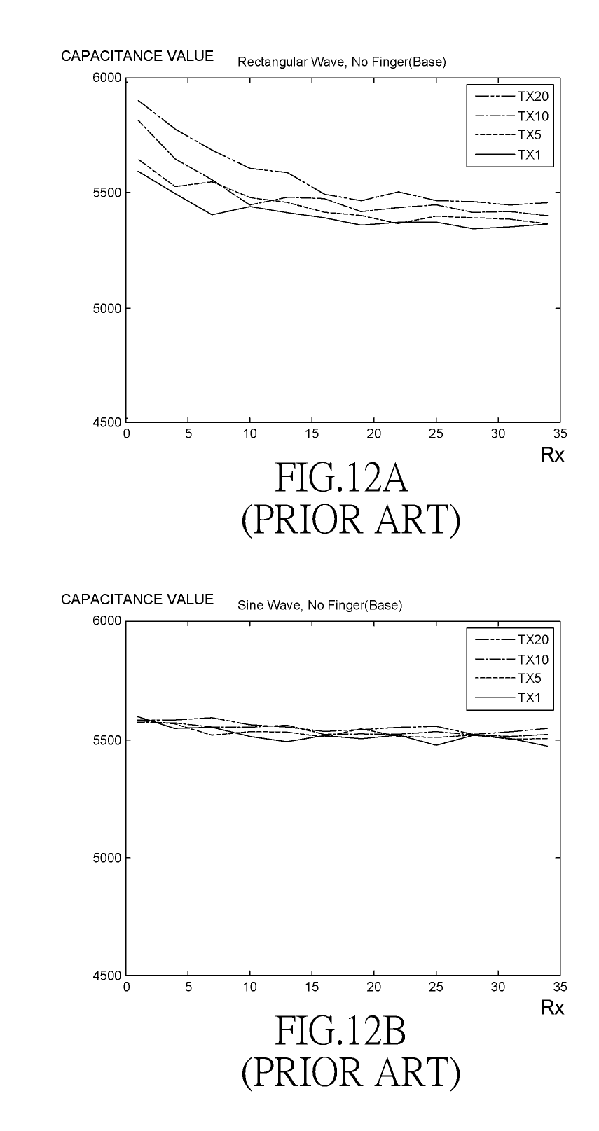

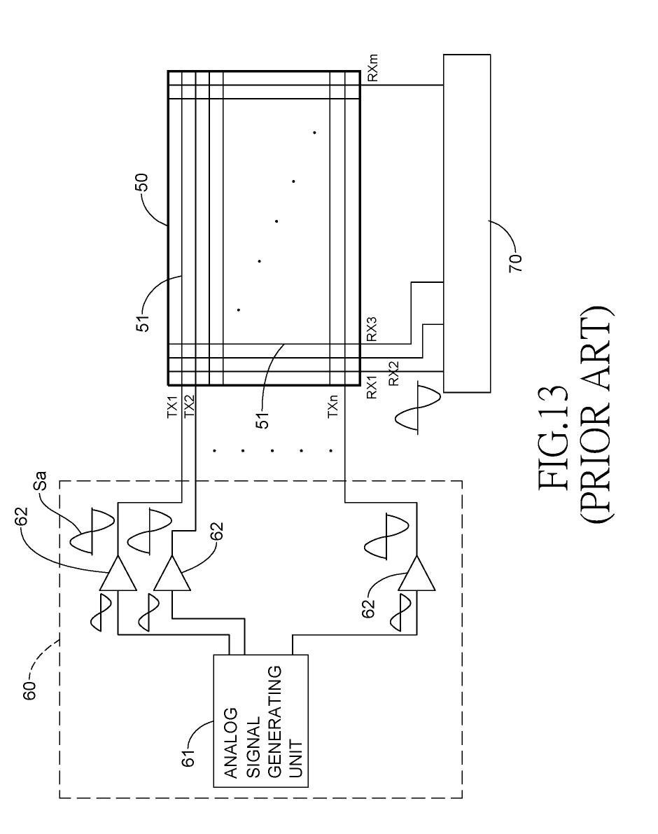

With further reference to FIG. 9, the signal converting unit 22 of the third to fifth preferred embodiments has an accumulator 221, a quantizer 222 and an output feedback circuit 223. A transfer function of the accumulator 221 is

$$H ( z ) = \frac{{Z}^{- 1}}{1 - {Z}^{- 1}}$$

to accumulate sets of input values x[n] of the input signal S3. The quantizer 222 is connected to an output terminal of the accumulator 221 to quantize each output value of the accumulator 221. The output feedback circuit 223 delays the quantized output value y[n] and then feeds back to an input terminal of the accumulator 221 to calculate a next input value of the accumulator 221 by subtracting quantized output value y[n] from a next external input value x[n+1]. An output terminal of the quantizer 223 is connected to the common pin(s) of the one to many multiplexer 213 and many to many multiplexer 213a in FIGS. 6 and 8, or directly connected to the corresponding first axis sensing trace TX1˜TXn as shown in FIG. 7. Referring to a list below, a 8-bit look-up table 201 is used as an example to describe the signal converting unit 22 can output PDM signal, wherein x[n] is the input value of a digital sine wave signal in decimal system. Sampled values (in decimal system) from sampling an analog sine wave signal are used as the input values x[n]. Each sampled value is transferred to 8-bit binary data to store in the 8-bit look-up table 201. When the controller 211 read the 8-bit binary data of the first line of the look-up table 201 and then converters the 8-bit binary data to the input value x[1] of the signal converting unit 22. The 8-bit binary data of the first line is [00000000] and the converted the input value x[1] is 0. The x[1] is inputted to the accumulator 221 and quantizer 222 and then the output value y[1] of the quantizer 222 is 1. The controller 211 reads and converters the 8-bit binary data of a second line to the input value x[2]=0.0628. A next real input value of the accumulator 221 is a difference by subtracting y[1] from the input value x[2]. The difference is inputted to the accumulator 221 and quantizer 222 and then the output value y[2] of the quantizer 222 is −1 and so on the third column y[n] of the list present the PDM signal.

| x[n] | 8-bit binary data of digital wave data | | | | | | | | y[n] |
|---|---|---|---|---|---|---|---|---|---|
| 0 | 0 | 0 | 0 | 0 | 0 | 0 | 0 | 0 | 1 |
| 0.0628 | 0 | 0 | 0 | 1 | 0 | 0 | 0 | 0 | −1 |
| 0.1253 | 0 | 0 | 1 | 0 | 0 | 0 | 0 | 0 | 1 |
| 0.1874 | 0 | 0 | 1 | 1 | 0 | 0 | 0 | 0 | −1 |
| 0.2487 | 0 | 0 | 1 | 1 | 1 | 1 | 1 | 1 | 1 |
| 0.309 | 0 | 1 | 0 | 0 | 1 | 1 | 1 | 1 | −1 |
| 0.3681 | 0 | 1 | 0 | 1 | 1 | 1 | 1 | 0 | 1 |
| 0.4258 | 0 | 1 | 1 | 0 | 1 | 1 | 0 | 1 | −1 |
| 0.4818 | 0 | 1 | 1 | 1 | 1 | 0 | 1 | 1 | 1 |
| 0.5358 | 1 | 0 | 0 | 0 | 1 | 0 | 0 | 1 | 1 |

In addition, the signal converting unit 22 may be a digital converter having a differential equations (a) and (b):

$$\begin{matrix}e [ n ] = x [ n ] - y [ n - 1 ] + e [ n - 1 ] ; and & ( a ) \\ y [ n ] = \{ \begin{matrix}+ 1 & x [ n ] \geq e [ n - 1 ] \\ - 1 & x [ n ] < e [ n - 1 ]\end{matrix} . & ( b )\end{matrix}$$

The e[n] is a present quantization error value, e[n−1] is a previous quantization error value and e[−1]=0, and x[n] is a present input value, x[n−1] is a previous input value, y[n] is a present output value and y[n−1] is previous output value. As shown in the above list, the output values y[n] shown in the third column thereof can be obtained by respectively input the input values x[n] in the equations (a) and (b). Therefore, the digital converter also generates the PDM signal.

Based on the foregoing description, the processing frequency (fm) of the signal converting unit 22 must correspond to the frequency (fs) of the digital wave data or higher than the frequency fs of the corresponding digital wave data to successfully convert the correct PDM signal. Therefore, the processing frequency (fm) of the signal converting unit 22 and the frequency (fs) of the digital wave data meet an equation: fm/fs>n, wherein n is an integer and greater than 4 or equal to 4.

In addition, the RC loading circuits 40 can be respectively connected between the first axis sensing traces and the signals, the output pins of the multiplexer 213, 213a in the third to fifth preferred embodiments. The RC loading circuits 40 with RC loads from small to large are respectively connected to the first axis sensing traces with the current transmission paths from long to short, i.e. the RC loading circuit with smaller RC load connected to the first axis sensing trace with longer current transmission path and the RC loading circuit with larger RC load connected to the first axis sensing trace with shorter current transmission path. Therefore, the higher capacitance value of the shorter current transmission path is solved.

As above descriptions for the first to fifth preferred embodiments, the excitation signal generating method of the capacitive touch device of the present invention mainly generates at least one PDM signal according to the frequency of the at least one excitation signal and supplies the at least one PDM signal used as the least one excitation signal to the sensing traces. The preferred excitation signal is sine wave signal. The PDM signal is used as the excitation signal since the frequency of the PDM signal is the same as that of the excitation signal. The PDM signal is recovered to an analog excitation signal since the PDM signal passes through a current transmission path, which is equivalent to a low pass filter. Therefore, a receiving circuit receives an available analog sensing signal with low signal distortion to increase accuracy of the current sensing signal. Further, the capacitive touch device does not require amplifiers to amplify the PDM signal, so a circuit structure of the excitation signal generating circuit is simplified, a manufacturing cost can be reduced, and the power consumption is low. If the controller and the signal converter is implemented by digital circuit and fabricated to an integrated circuit on chip, the layout area is decreased in comparison with implementing the analog circuit. Therefore, the fabricating cost is decreased to implement a low profile and light electric device.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An excitation signal generating circuit of a capacitive touch device, which is used to electronically connected to multiple sensing traces, comprising:
a storage unit storing at least one set of digital data and each of set of digital data corresponding to a frequency;
a pulse density modulation (PDM) signal generating circuit connected to the storage unit and the sensing traces to read the set of digital data of the storage unit, converting the read set of digital data to a PDM signal according to the frequency of the read set of digital data and outputting the PDM signal to the sensing traces.

2. The excitation signal generating circuit as claimed in claim 1, wherein each set of digital data is a set of digital wave data, and the PDM signal generating circuit further comprises:
a controller connected to the storage unit to read the set of digital wave data and generating an output signal according to the read set of digital wave data; and
at least one signal converting unit connected between the controller and the sensing traces to receive the output signal and convert the output signal to the PDM signal.

3. The excitation signal generating circuit as claimed in claim 2, wherein each set of digital wave data is a set of digital sine wave data and the set of digital sine wave data is generated by sampling an analog sine wave signal having a frequency the same as that of the set of digital sine wave data and an amplitude the same as that of the set of digital sine wave data.

4. The excitation signal generating circuit as claimed in claim 3, wherein
the storage unit has a single look-up table to store a single set of digital data; and
the single signal converting unit has an input terminal and an output terminal, wherein the input terminal is connected to the controller and the output terminal is connected to a common pin of a one to many multiplexer, wherein the one to many multiplexer has multiple output pins connected to the sensing traces.

5. The excitation signal generating circuit as claimed in claim 3, wherein
the storage unit has a single look-up table to store k sets of digital data, wherein k>1 and the output signals converted from the sets of digital sine wave data are orthogonal to each other; and
each of the signal converting unit has an input terminal and an output terminal, wherein the input terminals of the signal converting units are commonly connected to the controller and the output terminals of the signal converting units are connected to multiple common pins of a many to many multiplexer, wherein the many to many multiplexer has multiple output pins connected to the sensing traces.

6. The excitation signal generating circuit as claimed in claim 3, wherein
the storage unit has k look-up tables to respectively store the sets of digital data, wherein k>1 and the output signals converted from the sets of digital sine wave data are orthogonal to each other; and
each of the signal converting unit has an input terminal and an output terminal, wherein the input terminals of the signal converting units are commonly connected to the controller and the output terminals of the signal converting units are connected to multiple common pins of a many to many multiplexer, wherein the many to many multiplexer has multiple output pins connected to the sensing traces.

7. The excitation signal generating circuit as claimed in claim 5 wherein the k sets of digital wave data comprises:
k sets of digital sine and cosine wave signal data with the same frequency and phase;
k sets of digital sine wave signal data with the same frequency and different phases; or
k sets of digital cosine wave signal data with the same frequency and different phases.

8. The excitation signal generating circuit as claimed in claim 6, wherein the k sets of digital wave data comprises:
k sets of digital sine and cosine wave signal data with the same frequency and phase;
k sets of digital sine wave signal data with the same frequency and different phases; or
k sets of digital cosine wave signal data with the same frequency and different phases.

9. The excitation signal generating circuit as claimed in claim 5, wherein the k sets of digital wave data comprises k sets of digital sine or cosine wave signal data with different frequencies, and the frequencies of the k sets (j) of digital sine or cosine wave data meet 2̂(j−1)fs, wherein the fs is the lowest frequency thereof and j is one of the positive integers from 1 to k.

10. The excitation signal generating circuit as claimed in claim 6, wherein the k sets of digital wave data comprises k sets of digital sine or cosine wave signal data with different frequencies, and the frequencies of the k sets (j) of digital sine or cosine wave data meet 2̂(j−1)fs, wherein the fs is the lowest frequency thereof and j is one of the positive integers from 1 to k.

11. The excitation signal generating circuit as claimed in claim 2, wherein the signal converting unit comprises:
an accumulator having an input terminal, an output terminal and a transfer function H(z), wherein the input terminal receives input values in sequence and
$$H ( z ) = \frac{{Z}^{- 1}}{1 - {Z}^{- 1}} ;$$
a quantizer connected to the output terminal of the accumulator to quantize each output value of the accumulator to generate the PDM signals; and
an output feedback circuit delaying a quantized output value from the quantizer and then feeding back to the input terminal of the accumulator, wherein a next input value of the accumulator is calculated by subtracting quantized output value from a next external input value.

12. The excitation signal generating circuit as claimed in claim 2, wherein the signal converting unit is a digital converter and has differential equations (a) and (b):
$$\begin{matrix}e [ n ] = x [ n ] - y [ n - 1 ] + e [ n - 1 ] ; and & ( a ) \\ y [ n ] = \{ \begin{matrix}+ 1 & x [ n ] \geq e [ n - 1 ] \\ - 1 & x [ n ] < e [ n - 1 ]\end{matrix} , & ( b )\end{matrix}$$
wherein
the e[n] is a present quantization error value, e[n−1] is a previous quantization error value and e[−1]=0, and x[n] is a present input value, x[n−1] is a previous input value, y[n] is a present output value and y[n−1] is previous output value.

13. The excitation signal generating circuit as claimed in claim 2, wherein a processing frequency (fm) of the signal converting unit corresponds to a frequency (fs) of the digital wave data and meets an equation: fm/fs>n, wherein n is an integer and greater than 4 or equal to 4.

14. The excitation signal generating circuit as claimed in claim 1, wherein
each set of digital data of the storage unit is a set of digital pulse density modulation (PDM) data; and
the PDM signal generating circuit further comprises:
a controller connected to the storage unit to read the set of digital PDM data and generating a control signal according to the read set of digital PDM data; and
a switching circuit having two switching terminals, at least one common terminal and a control terminal, wherein the two switching terminals are respectively connected to two voltage terminals having different voltages, each of the at least one common terminal is selectively connected to the sensing traces and the control terminal is connected to the controller;
wherein the switching circuit generates the PDM signal by switching each of the least one common terminal between the two voltage terminals according the control signal.

15. The excitation signal generating circuit as claimed in claim 14, wherein a switching frequency (fsw) of the switching circuit corresponds to a frequency (fs) of the digital wave data and meets an equation: fsw/fs>n, wherein n is an integer and greater than 4 or equal to 4.

16. The excitation signal generating circuit as claimed in claim 1, further comprising multiple RC loading circuits with different RC loadings respectively connected between the sensing traces and the PDM signal generating circuit, wherein the RC loading circuits with RC loads from small to large are respectively connected to the sensing traces with current transmission paths from long to short.

17. A capacitive touch device, comprising:
a touch panel having multiple sensing traces;
an excitation signal generating circuit comprising:
a storage unit storing at least one set of digital data and each of set of digital data corresponding to a frequency; and
a pulse density modulation (PDM) signal generating circuit connected to the storage unit and the sensing traces to read the set of digital data of the storage unit, converting the read set of digital data to a PDM signal according to the frequency of the read set of digital data and outputting the PDM signal to the sensing trace; and
a receiving circuit connected to the sensing traces of the touch panel and receiving analog sensing signals from the sensing traces corresponding to the sensing trace to which the PDM signal is supplied.

18. The capacitive touch device as claimed in claim 17, wherein each set of digital data is a set of digital wave data, and the PDM signal generating circuit further comprises:
a controller connected to the storage unit to read the set of digital wave data and generating an output signal according to the read set of digital wave data; and
at least one signal converting unit connected between the controller and the sensing traces to receive the output signal and convert the output signal to the PDM signal.

19. The capacitive touch device as claimed in claim 17, wherein the receiving circuit further comprises:
a multiplexer having a common pin and multiple output pins connected to the sensing traces;
an analog to digital converter connected to the common pin to time division obtaining the analog signals from the sensing traces and converting each analog signal to a digital signal; and
a low pass filter connected to the analog to digital converter through a mixer, wherein a oscillating frequency of the mixer is the same as that of the received analogy signal to filter noise included in the received analog signal.

20. The capacitive touch device as claimed in claim 17, the receiving circuit further comprises:
a multiplexer having multiple common pins and multiple output pins connected to the sensing traces;
multiple analog to digital converters respectively connected to the common pins to obtaining the analog signals from the sensing traces at the time and converting the analog signals to digital signals; and
multiple low pass filters each of which is connected to the analog to digital converter through a mixer, wherein a oscillating frequency of each mixer is the same as that of the received analog signal from the corresponding analog to digital converter to filter noise included in the received analog signal.

21. The capacitive touch device as claimed in anyone of claim 17, further comprising multiple RC loading circuits with different RC loadings respectively connected between the sensing traces of the touch panel and the PDM signal generating circuit, wherein the RC loading circuits with RC loads from small to large are respectively connected to the sensing traces with current transmission paths from long to short.

22. The capacitive touch device as claimed in claim 17, wherein
each set of digital data of the storage unit is a set of digital pulse density modulation data; and
the PDM signal generating circuit further comprises:
a controller connected to the storage unit to read the set of digital PDM data and generating a control signal according to the read set of digital PDM data; and
a switching circuit having two switching terminals, at least one common terminal and a control terminal, wherein the two switching terminals are respectively connected to two voltage terminals having different voltages, each of the at least one common terminal is selectively connected to the sensing traces and the control terminal is connected to the controller;
wherein the switching circuit generates the PDM signal by switching each of the least one common terminal between the two voltage terminals according the control signal.

23. An excitation signal generating method of a capacitive touch device having multiple sensing traces, comprising steps of:
(a) storing at least one set of digital data, each of which corresponds to a frequency;
(b) converting the set of digital data to a pulse density modulation (PDM) signal according to the frequency of the set of digital data; and
(c) supplying the PDM signal using as excitation signal to the sensing traces.

24. The excitation signal generating method as claimed in claim 23, wherein the step (b) further comprises:
(b1) converting the set of digital data to an output signal, wherein the set of digital data is a set of digital wave data; and
(b2) converting the output signal to the PDM signal through a signal converting unit.

25. The excitation signal generating method as claimed in claim 24, wherein each set of digital wave data is a set of digital sine wave data and the set of digital sine wave data is generated by sampling an analog sine wave signal having a frequency the same as that of the set of digital sine wave data and an amplitude the same as that of the set of digital sine wave data.

26. The excitation signal generating method as claimed in claim 25, wherein the least one set of digital wave data comprises multiple sets of digital wave data and the multiple sets of digital wave data further have:
multiple sets of digital sine and cosine wave signal data with the same frequencies and phases;
multiple sets of digital sine wave signal data with the same frequency and different phases; or
multiple sets of digital cosine wave signal data with the same frequency and different phases.

27. The excitation signal generating method as claimed in claim 25, wherein the least one set of digital wave data comprises multiple sets of digital wave data and the multiple sets of digital wave data further have multiple sets of digital sine or cosine wave signal data with different frequencies, and the frequencies of the k sets (j) of digital sine or cosine wave data meet 2̂ (j−1)fs, wherein the fs is the lowest frequency thereof and j is one of the positive integers from 1 to k.

28. The excitation signal generating method as claimed in claim 24, wherein a processing frequency (fm) of the signal converting unit corresponds to a frequency (fs) of the digital wave data and meets an equation: fm/fs>n, wherein n is an integer and greater than 4 or equal to 4.

29. The excitation signal generating method as claimed in claim 23, wherein the step (b) further comprises:
(b1) converting the set of digital data to a control signal, wherein the set of digital data is a set of digital pulse density modulation (PDM) data; and
(b2) generating the PDM signal by controlling a switching circuit according to the control signal.

30. The excitation signal generating method as claimed in claim 29, wherein a switching frequency (fsw) of the switching circuit corresponds to the frequency (fs) of the digital wave data and meets an equation: fsw/fs>n, wherein n is an integer and greater than 4 or equal to 4.
